(19) United States
(12) Patent Application Publication
(10) Pub. No.: US 2014/0050901 A1
(43) Pub. Date: Feb. 20, 2014

(54) METHOD OF PROVIDING A FIRE-RESISTANT LAMINATE HAVING A PRINT ADVERTISEMENT FOR A CABIN COMPONENT OF AN AIRCRAFT

(71) Applicant: Global Onboard Partners, LLC, Atlanta, GA (US)

(72) Inventor: Kirk R. Adams, Smyrna, GA (US)

(73) Assignee: Global Onboard Partners, LLC, Atlanta, GA (US)

(21) Appl. No.: 14/047,806

(22) Filed: Oct. 7, 2013

Related U.S. Application Data
(63) Continuation-in-part of application No. 13/084,839, filed on Apr. 12, 2011, now abandoned.
Application No. 13/084,839 is a continuation-in-part of application No. PCT/US2009/056207, filed on Sep. 8, 2009.
(60) Provisional application No. 61/095,148, filed on Sep. 8, 2008.

(51) Int. Cl. B64D 45/00; C09J 7/04

(52) U.S. Cl. CPC B64D 45/00; C09J 7/045
USPC 428/196; 156/327; 156/250; 156/277

(57) ABSTRACT

An advertisement laminate meets the fire-resisting requirements needed for placement inside of an aircraft cabin. The laminate includes several specifically configured adhesively attached layers, including a fire protection barrier layer, a printed advertisement layer which is visible to passengers, and a transparent protective cover layer. The laminate is equipped for being adhesively adhered to an interior component of the aircraft cabin, such as an overhead storage bin, an overhead bin door, a sidewall panel, a bulkhead, window surround, or any other area inside the aircraft which must meet FAR 25.853 requirements.

### CROSS-REFERENCE TO RELATED APPLICATIONS

This application is a continuation-in-part of U.S. patent application Ser. No. 13/084,839 filed Apr. 12, 2011, which is a continuation-in-part of International PCT Patent Application No. PCT/US2009/056207 filed Sep. 8, 2009, which claims the benefit of U.S. Provisional Patent Application 61/095,148 filed Sep. 8, 2008, and these applications are herein incorporated by reference in their entireties for all purposes.

### TECHNICAL FIELD

The present invention generally relates to the fields of fire-resistant materials and display systems, and more particularly to a fire-resistant material system and a related method for reducing heat release and smoke density, and to display systems and method incorporating such a material system.

### BACKGROUND

In the United States, the Ohio State University (OSU) Heat Release Test and apparatus is commonly used to measure the heat release rate (HRR) of materials and products in forced flaming combustion. Similar tests and apparatus may be used by other countries and/or governmental entities, at present or in the future. The OSU test measures oxygen consumption and sensible enthalpy (temperature rise) of the apparatus in addition to the usual sensible enthalpy of smoke density and/or the exhaust gases during the test. The test is used in the aircraft field to expose aircraft interior cabin materials (parts) to an incident radiant heat flux of approximately 35 kW/m² in order to comply with FAR 25.853 requirements. FAR 25.853a is a vertical Bunsen burner test designed by the FAA (Federal Aviation Administration) for cabin and cargo compartment materials. FAR 25.853d is comprised of two separate tests: the OSU Rate of Heat Release and the Specific Optical Density of Smoke Generated by Solid Materials. FAR 25.853d helps to determine the acceptability of the materials for use in the interiors of aircrafts. In order to pass this test under currently recognized parameters, interior cabin materials (parts) must not provide a heat release measurement which exceeds 65 kW/m² at a peak or 65 kW min/m² for a two minute period (<65/65) to pass. That is, the total heat release within the First 2 Minutes must be <=65 kW minutes per square meter, and the peak heat release rate must be <=65 kW per square meter. A test similar to the OSU Heat Release Test and apparatus may be used by the FAA or other countries' regulatory or governmental entities to test compliance with other present or future applicable regulations or standards.

Many interior aircraft parts burn at or near the 65/65 HRR measurement on their own. Thus, if even a single layer of most any type of previously known graphic display material is added or adhered to the aircraft part, the measurement (using the combined display material and aircraft part) will typically exceed the OSU 65/65 measurement. Rather, often times the combination will produce heat release in excess of 80 kW/m² (+/−) at a peak and 80 kW min/m² (+/−) over a 2 minute period for a score of 80/80 (+/−), resulting in a greatly failed test. Thus, the possibility is absent for an airline (or media company) to be able to install the graphic display material onto that specific aircraft interior material/part. Again, when a previously known graphic display material is applied to airline parts and undergoes these tests (with their stringent levels and criteria), the heat release and smoke density typically dramatically increase, resulting in failure of the test, and limiting the potential areas where graphic display materials can be applied on an aircraft.

Results from the Smoke Density Test required by the FAA are expressed in terms of specific optical density (Ds). The Smoke Density Test results in a failure for conditions that produce Max Ds (maximum specific optical density) at four minutes>200. That is, at 4.0 minutes the smoke density (Ds) must be <=200. Thus, the smoke density from any aircraft interior material/part cannot exceed 200 over a four minute period. When previously known graphic display materials are placed on top of, or adhered to, these aircraft materials/parts and subjected to the Smoke Density test, they commonly exceed the allowable levels of smoke density, thus further inhibiting the application of graphic display materials inside the cabin on airline materials/parts. Similar tests and ways of measuring smoke density may be used by the FAA or other countries' governmental agencies now or in the future to test compliance with applicable regulations or standards.

### SUMMARY

Airlines are constantly seeking ways to increase revenue, especially during times when fuel costs and increased competition make it increasingly more difficult to remain financially viable. Many airlines are turning to non-transportation related revenue opportunities to offset these costs. Presently some airlines use advertising media inside the airplane cabin as a means of increasing non-transportation related revenue. Accomplishing this can provide an airline with millions of dollars in increased revenue, thus leading to greater job security for employees and greater overall financial strength and viability for the airline. Known forms of advertising inside an airliner cabin environment are typically limited to areas such as the back or front of the tray tables, which only require passage of the FAA's Vertical Burn Test, or similar tests which can be passed by displays applied using standard graphic display materials. However, exemplary embodiments of the new invention when used on tray tables greatly reduce the possibility of smoke or fire in the cabin due to its unique properties, thus enhancing an ability to make the cabin safer over any previous art specific to the tray table.

The challenge comes when an airline or media company desires to place display materials such as graphics or advertisements in areas inside the cabin such as the overhead bin doors, sidewall panels, bulkhead/windscreens, and other areas on the interior of the aircraft which require testing beyond the Vertical Burn Test standards and to meet the strict standards of the FAA and other governmental entities. These additional tests include the OSU Heat Release and Smoke Density Tests, or other tests set forth by other countries' governmental agencies. Such tests are typically required prior to placing display materials on aircraft material/parts where the size of the graphic material exceeds 6″×6″ for heat release and 3″×3″ for smoke density. Other size requirements may be less than or greater than 6″×6″ for heat release and 3″×3″ for smoke density testing, as determined by the applicable country's government agency or standards. To applicant's knowledge, no previously known (fire-resistant) arrangement of materials have permitted display materials to be directly adhered to aircraft cabin components in compliance with these rigid safety tests and standards.

Exemplary embodiments provide a material system that allows an airline, media company, or other entity, to comply with the required FAA OSU tests and/or other tests required by any government regulation or standard, to enable the application of various forms of displays on aircraft material/parts. Example forms of exemplary embodiments allow the application of display materials directly onto aircraft cabin parts in compliance with the OSU Heat Release and Smoke Density Tests. This results in the first ever passing of the test from the FAA for such materials, allowing such display materials to be placed on commercial registered airline aircraft as a direct result of the structure set forth in exemplary embodiments. With the creation of the exemplary method and apparatus for reducing heat release and smoke density, which allows exemplary structure to be adhered directly to an aircraft cabin part, a Supplemental Type Certificate or other government documentation can be accepted by other governmental entities around the globe according to bi-lateral agreements between countries. This makes the exemplary embodiments that much more valuable, as they are accepted and can be used to benefit a greater number of airlines around the globe. As such, the exemplary embodiments are expected to provide the same or similar benefits when applied to similar tests by other countries' governmental agencies, which tests require a reduction in the amount of heat release and/or smoke density in order to install display structures on aircraft material/parts.

By incorporating the novel aspects of the exemplary embodiments discussed herein, airlines, media companies, or any other entities performing these tests will be able to see the heat release and smoke density reductions, allowing them to pass each test. This further enables airlines to generate additional non-transportation (e.g., advertising) related revenue, which in turn will provide the airlines with greater financial stability, greater job security, and viability of the airline.

According to example forms of the exemplary embodiments, a fire protection barrier material or composition is sandwiched between the display element and the aircraft part. The fire barrier material can also be placed directly onto the aircraft materials/parts in a more permanent fashion. In the event that the barrier is placed directly onto the aircraft materials/parts, it only needs to be changed out in the event it becomes torn or damaged. The barrier dramatically reduces the ability for fire to penetrate the barrier and reach the aircraft materials/parts, as well as lowers the overall thermal conductivity. As a direct result of the exemplary embodiments, when fire is unable to fully reach the aircraft material/parts, the amount of heat and/or smoke density released is dramatically inhibited and reduced, which allows the graphic material adhered to the aircraft material/parts to pass the required FAA tests (and any other tests required by any country's government to accomplish the same goal of installing display material on aircraft material/parts). When the aircraft material/part does not catch on fire, the smoke density is dramatically reduced, allowing the airline/media company to pass the stringent Smoke Density Test.

Exemplary embodiments dramatically inhibit the fire from transferring from the graphic material into the interior airline material/part. Exemplary embodiments lower the heat release when the graphic display material is adhered to the fire barrier material, which in turn is adhered to (or placed on) the aircraft's interior material/part/component. The exemplary embodiments also lower the produced smoke density when the graphic display material is placed (located) in front of the fire barrier. The exemplary embodiments do not suffer the problems of previous deficiencies that existed when trying to pass the FAA (and other governmental) tests when combining graphic material with the interior aircraft material/parts.

In one aspect, an exemplary embodiment relates to a graphic display material having a fire barrier material, where display information is applied (e.g., via ink) onto the graphic display material. The fire protective barrier material can be selected from one or more of: a ceramic-based material, a ceramic based paint, an insulating thermal barrier coating, an aluminum material, a polymeric flame resistant material, an aramid, a hybrid aramid/inorganic fiber based material, a woven glass fiber, and a melamine-based fiber, and/or combinations thereof.

In another aspect, an exemplary embodiment relates to an aircraft component which has a fire barrier material applied onto it, where the fire barrier receives display information material. The fire barrier material is selected from one or more of: a ceramic-based material, a ceramic based paint, an insulating thermal barrier coating, an aluminum material, a polymeric flame resistant material, an aramid, a hybrid aramid/inorganic fiber based material, a woven glass fiber, and/or a melamine-based fiber.

In still another aspect, an exemplary embodiment relates to a method of presenting information onto a display surface, where the method includes several steps. A fire barrier material is adhered to the display surface with adhesive. A transparent outer layer is applied to the display surface with adhesive.

In still another aspect, an exemplary embodiment relates to a method of reducing thermal conductivity, heat release, and/or smoke density. A fire barrier product is applied behind a graphic material. The fire barrier product is configured to pass the OSU Heat Release Test.

In another aspect, an exemplary embodiment relates to a surface covering material which includes a plurality of layers. The layers include at least two materials selected from a fire barrier material, a graphic display material, and a transparent cover material.

In another aspect, an exemplary embodiment relates to a graphic display laminate for application to airline components. The laminate structure includes an inner fire-barrier layer of at least one material selected from a ceramic-based material, a ceramic based paint, an insulating thermal barrier coating, an aluminum material, a polymeric flame resistant material, an aramid, a hybrid aramid/inorganic fiber based material, a woven glass fiber, a melamine-based fiber, and/or combinations thereof. The laminate structure also includes a transparent, translucent, or otherwise light-transmissive outer protective layer. The laminate also includes a graphic display layer (which includes visible artwork, message, or advertisement, etc.) between the inner fire-barrier layer and the light-transmissive outer protective layer.

These and other aspects, features and advantages of the exemplary embodiments will be understood with reference to the detailed description herein, and will be realized by structure and arrangements of the various elements and combinations particularly pointed out in the appended claims. It is to be understood that both the foregoing general description and the following detailed description of the embodiments are exemplary, and are not to be in any manner restrictive of the invention as claimed.

### DESCRIPTION OF THE FIGURES

FIG. 1 shows displays incorporating fire barrier material in an airplane cabin, according to example forms of exemplary embodiments.

FIG. 2 shows an exploded side cross-sectional view of a fire barrier display system for application to the surface of an airline storage compartment, according to an example form of an exemplary embodiment.

FIG. 3 shows an enlarged cross-sectional view of a portion of the fire barrier system shown in FIG. 2.

FIG. 4 shows a cross-sectional view of a portion of an exemplary embodiment of a laminate structure attached to an aircraft component.

FIG. 5 shows a cross-sectional view of a portion of an alternative exemplary embodiment of a laminate structure attached to an aircraft component.

FIG. 6 shows an exemplary display laminate attached to a bulkhead.

FIG. 7 shows another exemplary display laminate attached to a tray table.

FIG. 8 shows another exemplary display laminate attached to aside wall panel.

FIG. 9 shows another exemplary display laminate attached to an overhead bin/door.

FIG. 10 shows an exemplary display laminate that is configured for attachment to a surface above a window.

FIG. 11 shows an exemplary display laminate that is configured for attachment to an overhead bin.

FIG. 12 shows an exemplary display laminate that is configured for attachment to a bulkhead surface.

FIG. 13 shows an exemplary display laminate that is configured for attachment to a bulkhead surface.

FIG. 14 shows an exemplary display laminate that is configured for attachment to a bulkhead surface.

FIG. 15 shows an exemplary display laminate that is configured for attachment to a bulkhead surface.

FIG. 16 shows an exemplary display laminate that is configured for attachment to a bulkhead surface.

FIG. 17 shows an exemplary display laminate that is configured for attachment to a tray table.

FIG. 18 shows an exemplary display laminate that is configured for attachment to a tray table.

### DETAILED DESCRIPTION OF EXEMPLARY EMBODIMENTS

The exemplary embodiments may be understood more readily by reference to the following detailed descriptions. It is to be understood that the exemplary embodiments are not limited to the specific devices, methods, conditions, or parameters described herein, and that the terminology used herein is for the purpose of describing particular embodiments by way of example only and is not intended to be limiting of the claimed invention. Any and all patents and other publications identified in this specification are incorporated herein by reference as though fully set forth herein in their entirety.

Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

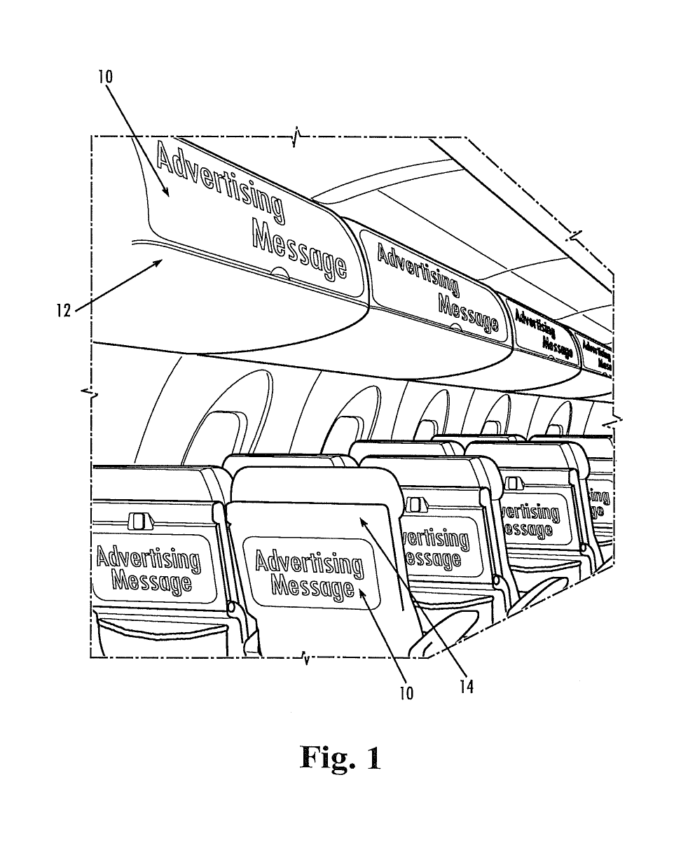

FIG. 1 shows an example embodiment of a fire barrier display material 10 having displayed material such as advertising or informational text and/or graphics in use within an airplane cabin. The fire barrier display material 10 can be affixed to the overhead storage compartment surface 12, the back of a seat or fold-up table 14, bulkhead walls, cabin ceilings, sidewall panels, and/or other cabin surfaces. The fire barrier display material 10 acts as a fire barrier or inhibitor, assists in lowering thermal conductivity and heat release, and/or lowers smoke density. The fire barrier display material 10 includes one or more layers of fire barrier compound or other fire-resistant product underlying a layer of graphic display material or other form of display surface, creating a graphic sandwich or layered laminate system, wherein the graphic is placed on top of and adhered or otherwise affixed to the fire barrier material/compound used to reduce thermal conductivity, heat release and smoke density. The fire barrier compound or material is adhered or otherwise attached to the aircraft part 12. The graphic display material can be permanently affixed to the fire barrier compound or material, such that when the graphic display material is changed out, the fire barrier compound or material is changed out as well. Alternatively, the attachment between the graphic display material and the fire barrier compound or material is releasable, whereby the graphic display material can be removed and replaced, with the fire barrier compound or material remaining in place.

The fire barrier compound or material is also used as a base template where it is applied directly to the aircraft part and the graphic/advertisement material is applied on top of the fire barrier compound or material. When the graphic is removed or changed out, the fire barrier compound or material remains adhered to/attached to the aircraft part; or alternatively, is replaced or repaired if damaged during the removal process.

The fire barrier compound or material is placed behind any of a variety of types or styles of advertising graphic display material which can be printed on directly. These display materials include, but are not limited to vinyl, polyester synthetic, and/or any other manner of product upon which graphics can be printed.

The material upon which the graphic is printed may be covered with a fire retardant and/or graffiti resistant product, resin, layer or coating such as Lexan (e.g., a polycarbonate resin thermoplastic), Tedlar® (e.g., a PVF film), polycarbonate, glass, urethane, acrylic, or any other desirable and appropriate product, resin, layer, or coating.

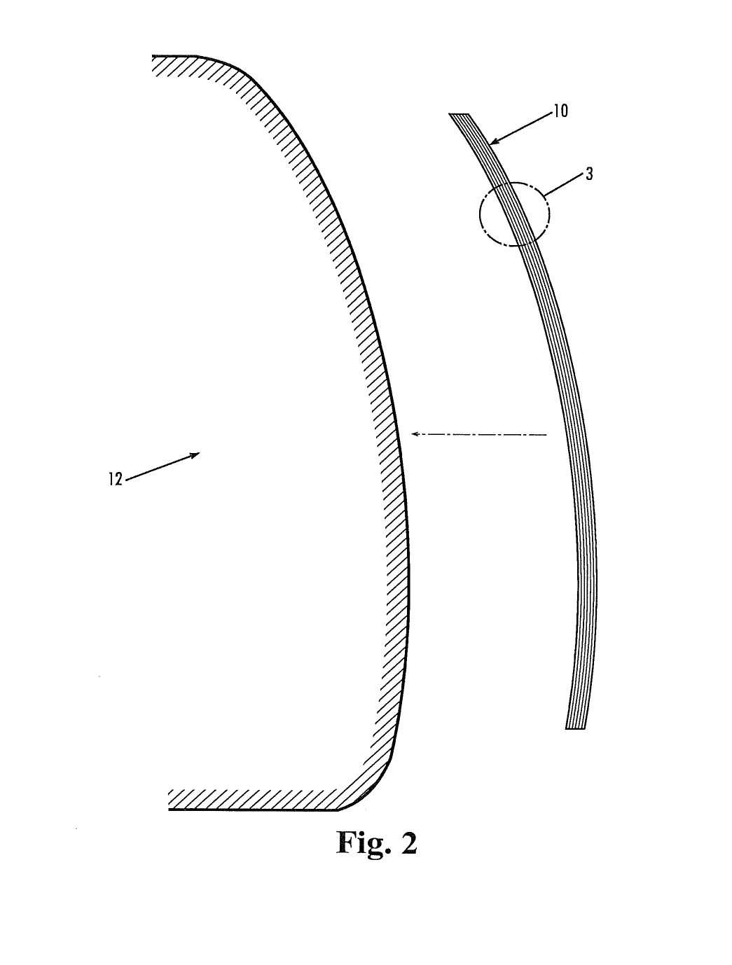

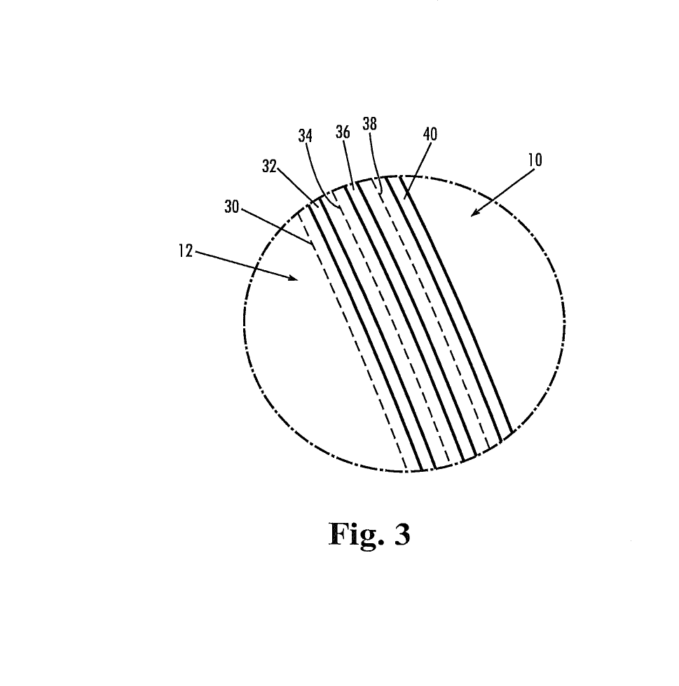

FIG. 2 shows an exploded cross sectional view of an example form of a fire barrier display material 10 according to an exemplary embodiment, separated from an overhead compartment storage surface 12. As shown, the example embodiment of the fire barrier display material 10 has six layers. FIG. 3 shows an enlarged cross sectional view of the layers of the fire barrier display material 10 as shown in FIG. 2. As shown, the example embodiment has six layers.

An outer layer 40 of transparent material acts as a cover. The outer layer 40 can comprise, for example, Tedlar®, Lexan, or other substantially transparent or translucent material or coating, and preferably is fire-resistant and graffiti and tamper-resistant. The outer layer 40 is affixed to a middle layer 36 of display material on which graphics can be printed or otherwise applied. The outer layer 40 is affixed to the middle layer 36 with an adhesive or bonding layer 38 to form a multi-layer laminate structure. The light and/or color transmissive nature of the outer layer 40 is such that printed material on the middle layer 36 is at least partially visible through the outer layer 40, and optionally is clearly and entirely visible therethrough.

The middle layer 36 can comprise, for example, a vinyl, polyester, or other material upon which graphics, text, or other display material are or can be printed or otherwise applied. Optionally, the middle layer is a paint, dye, pigment, stain, ink, print-media, foil, film, thermographic print media, or other graphic display media applied directly onto the outer layer and/or the inner layer in a self-adhesive fashion, without the need for application of a separate adhesive compound therebetween. Middle layer 36 is affixed to an inner layer 32.

The inner layer 32 is a fire barrier compound or material forming a firewall or fire-resistant barrier, for example comprising a ceramic-based fire barrier, an aluminum-based fire barrier, a polymer-based fire barrier, an aramid-based fire barrier, a hybrid aramid/inorganic fire barrier product, a melamine-based fire barrier, or other form of fire resistant material. The middle layer 36 is affixed to the inner layer 32 with an adhesive layer 34. The inner layer 32 is affixed to the surface 12 with an adhesive layer 30. The fire barrier product 10 inhibits and blocks a fire when affixed to the surface 12.

In alternate exemplary embodiments, the fire barrier display material 10 may optionally comprise any two or more layers selected from the inner layer 32, the middle layer 36 and/or the outer layer 40, each layer comprising at least one material selected from the example materials specified above for the respective layers. For example, embodiments comprising an inner layer material in combination with a middle layer material, a middle layer material in combination with an outer layer material, and/or an inner layer material in combination with an outer layer material, are contemplated to be within the scope of the exemplary embodiments, depending on the desired application and the particular selection of materials.

Placing the fire barrier material/product/compounds either in a sandwiched manner between the graphics materials and the airplane materials/parts or placed as a template barrier directly on the aircraft materials/parts may include any one or more combinations of the following materials, or any similar fire barrier materials that assist in lowering both heat release and smoke density when tested using the FAA OSU Heat Release and Smoke Density tests or any other test required by any countries governmental entity in order to allow an airline or media company to install graphics onto aircraft material/parts: ceramic-based felts, fibers, papers, and materials, which include alumina-silicate based products, and products within this same chemical composition family, are primarily made of Ab03, Si02, and/or B203, but can include any other ceramic based chemical composition which satisfactorily creates a fire barrier and assists in lowering thermal conductivity from the graphic into the airplane part as well as incorporating any additional benefits these products may provide.

The fire barrier layer thickness can be any range of thickness that maintains the fire barrier and continues to provide the necessary reductions in thermal conductivity required to pass the OSU Heat Release and Smoke Density Tests, or any other test any countries governmental entity may require to install graphics onto aircraft material/parts. Any layer of density is within the scope of the exemplary embodiments as long as it continues to perform as necessary under the fire and smoke conditions as required by the FAA (e.g., the OSU Heat Release and Smoke Density tests). The particular parameters of the barrier layer will be determined based on the selected materials of construction and the intended specific application or specific manner of use.

These barriers can typically resist continuous temperatures exceeding 1800 degrees Fahrenheit, as is required under the OSU Heat Release guidelines, or other countries governmental tests required to place graphics onto the interior aircraft materials/parts. One of the most significant attributes of Ceramic-based compounds is that they are typically not burned or melted in the event of a fuel fire.

In alternative embodiments, ceramic based paint and insulating thermal barrier coatings provide a strong heat reflecting, insulating, thermal barrier that can be sprayed directly onto the aircraft material/parts. The thermal barrier can also be applied directly onto a separate substrate which can then be (as part of a sandwiched form) placed behind the graphic display materials and applied directly to the aircraft materials/parts or onto a base template. The base template can be applied directly to/onto the aircraft material/part in a more permanent fashion, where the graphic display can be applied to and removed from the template. The ceramic based paint or coating can be in the form of a paint additive that when combined with paint creates the necessary radiant heat reflecting, insulating, thermal barrier coating, or it can be in a liquid form to be sprayed or applied or acquired and applied to the aircraft material/parts, or it can be in a sandwich form as a pre-sprayed/formed solid material that presents the same heat reflecting, insulating, thermal barrier properties, as well as incorporating any additional benefits these products may provide. Also, non-tumescent ceramic based paint, coatings or materials may provide better results, but intumescent and non-intumescent paints, coatings, and materials are within the scope of exemplary embodiments.

In still further exemplary embodiments, aluminum foils and/or tapes (which can adhere directly to any surface) are used to provide fire resistant properties that assist with lowering thermal conductivity and smoke density. They can be cut in standard strips and provided on rolls, or provided as a specialty cut to the desired width and length.

Additional exemplary embodiments comprise fire barrier layers selected from one or more polymer-based and/or polymeric flame-resistant materials, including without limitation, oxidized polyacrylonitrile-based (PAN) felt/product, aramid-based felt/product, melamine-based fabric, or hybrid aramid/inorganic fiber/felt/product. Such materials act as a sufficient barrier against fire and reduce thermal conductivity in the event of a fire in the aircraft cabin, as well as provide many additional benefits. PAN-based fiber can be blended with other fibers to produce a wide variety of felted, paper, or other product materials/compounds that provide excellent burn-through protection properties. These materials can be produced using numerous methods including ammoxidation or propylene.

Aramid is an abbreviation for aromatic polyamide. The chemical composition of a commercial aramid is poly-para-phenylene-terephthalamide. It may also be known as para-aramid. Aramid fiber/product is a man-made organic polymer produced by spinning a solid fiber from a liquid chemical blend. The bright golden yellow filaments produced have high strength and low density giving very high specific strength. Aramid materials do not ignite, melt, or drip, giving exceptionally beneficial characteristics when used in the cabin environment behind a graphic. Aramid materials are extremely flame-resistant and maintain extremely high tensile strength as well as incorporating the many additional benefits these materials and products may provide.

Hybrid aramid/inorganic fiber/product is another type of fire barrier material resulting from the combination between aramid material and ceramic oxides is the hybrid aramid/inorganic fiber/product. This material is usually formulated with the Nitrile Rubber (NBR) binder and exhibits a high strength, low thermal conductivity, and excellent fire resistance and incorporates the many additional benefits these fibers/products/materials may provide.

Melamine-based fiber/product can also be used to enhance the performance of fire blocking materials. It exhibits excellent heat insulation properties and provides low thermal conductivity. The distinct diameter distribution of these fibers can trap insulating air, further increasing the heat blocking characteristics of fire blocking fabrics, papers and other compounds, which can greatly assist in lowering heat transfer during the OSU Heat Release test and any other test required by any countries government entity in order to install graphic materials onto any interior aircraft material/part.

In an exemplary embodiment, a layered laminate structure comprises (in a first direction) an inner adhesive, a fire barrier, an intermediate adhesive, a film material with artwork printed on its outer side, an outer adhesive, and a protection cover. The inner adhesive is used to affix the laminate to the aircraft component. Thus when affixed to the aircraft component, the above laminate layers are in a sequential order that extends outwardly away from the component.

The exemplary display laminates discussed herein comprise specifically arranged layered materials which (because of their particular order, dimensions, and characteristics) allow the total laminate to meet FAA safety requirements (as previously discussed) for use in displaying artwork and/or messages on an interior component of an aircraft. That is, interior cabin parts applied with an exemplary laminate successfully achieved (during testing) heat release rates which did not reach a peak of 65 kW/m² or 65 kW min/m² for a two minute period. The specifically arranged order of the material layers (in the exemplary laminate) was a factor in passing the tests.

The aircraft component can be an overhead storage bin, an overhead bin door, a panel (e.g., a sidewall panel, a ceiling panel, sidewall above passenger window, etc.), a bulkhead, a window surround, a cargo liner, a closet door, a class divider, a seatback tray tables, a personal service unit (e.g., a panel above the passenger seat which may have air flow controls, a “call for service” input button, etc.), an in-flight entertainment system (e.g., video display), lavatory surfaces (e.g., mirrors, walls, inside of lavatory door), etc. The aircraft component can be located in the interior cabin of the aircraft. That is, all manner of aircraft cabin interior equipment, both for commercial and private planes, can be locations at which the exemplary laminate can be applied. The chosen aircraft component can be strategically positioned such that one or more passengers can view the message (e.g., onboard advertisement) during boarding, flight, and/or deplaning from the aircraft.

A single message (e.g., a visual graphics such as an advertisement or artwork) may be formed on a single laminate that is applied to a single aircraft component. Alternatively, a single message may be formed on a single laminate that is applied over several (sequentially) adjacent aircraft components (e.g., overhead storage bins). Similarly, a single message may be formed over a plurality of adjacent individual laminates that are applied to one or more aircraft components. In some embodiments, exemplary laminates can also be applied at strategic locations on the outside (exterior) of the aircraft. Thus, non passengers can also see the visually presented graphics.

An aircraft component may include polymer matrix composite materials, including thermoplastics (such as polyetheretherketone, polysulfone, polyethersulfone, polyphenylsulfone, and thermoplastic polyurethane (TPU) compositions), thermosets (thermoset resins such as phenolics), etc. For example, an interior panel may be fabricated from sheets of phenolic resin and fiberglass, with a polyaramid core. An aircraft component may be covered with highly formable decorative thermoplastic films.

The inner adhesive can comprise an adhesive tape. In an exemplary embodiment, the adhesive's thickness is approximately 2.0 mils (0.05 mm), and the tape's areal density is approximately 28.47 oz/ft² (75 g/m²). The adhesive tape can be double-coated with adhesive on both sides of a carrier, and double-lined with a release liner (e.g., a polycoated lay-flat kraft liner) on each side. Alternative, a single adhesive layer (without a carrier) can be covered with at least one (peel off) removable liner. A tape liner can be type 83# PCK (Polycoated Kraft) in the range of 6.2-6.5 mils, or 55# DK (Densified Kraft) in the range of 3.2-4.0 mils. An example of an adhesive tape that can be used in an exemplary laminate is 3M™ 9372 adhesive tape (tackified acrylic, 300FR series), with a polycoated kraft liner of 6.5 mils.

The fire protection barrier can comprise a coated fiberglass fabric material, which is silica-based (SiO2). The fabric can be woven from glass yarn. For example, the barrier can include a continuous filament fiber glass (fibrous glass) that comprises non-respirable filaments and particulate at approximately >98%, respirable particulate at approximately <1%, and respirable particulate with fiber-like dimensions (glass shards) at approximately <0.002%. The base fabric's nominal weight can be approximately 407 g/sq m (before application of coatings and/or treatments). The weight percent of the coated barrier can be approximately 82-87%, with the weight percent of the coating being approximately 13-18%.

The coating composition can include at least one halogenated flame retardant compound. The flame retardant compound can be selected from the group consisting of chlorinated compounds and brominated compounds. The level of halogenated flame retardant compounds used in the coating composition can be from about 3 to about 25 (preferably 6-15) weight percent of the composition.

Suitable brominated flame retardant compounds include those selected from the group consisting of decabromo diphenyloxide (Saytex® 102E), benzene, 1,1′-(1,2-ethanediyl)bis[2,3,4,5,6-pentabromo-] (Saytex® 8010), and 1,2-bis(tetrabromophthalimido)ethane (Saytex®BT-93W), and mixtures thereof. These are available from Albemarle Corporation. Saytex® 8010 may also be referred to as ethane-1,2-bis(pentabromophenyl) and has a formula of Br₁₀C₁₄H₄. The brominated compounds can have a bromine content of from about 60 to about 85 weight percent bromine. Chlorinated flame retardant compounds can include a C₁₈H₁₂Cl₁₂ compound that is available from Occidental Chemical Corporation under the name Dechlorane Plus®.

The coating composition can include at least one antimony oxide compound from the group consisting of antimony trioxide and antimony pentaoxide. Antimony oxide can be present at a level of from 30-70 weight % of the level of halogenated flame retardant, and more preferably from 45-55 wt %. In an exemplary example, the antimony trioxide level is from 2.0-8.0 wt % of the composition, with a preferred level from 2.5-3.5 wt %. Thus, an exemplary coating can include decabromo diphenyl oxide at approximately 7% and antimony trioxide at approximately 3%.

The coating composition may additionally include talc (i.e., Mg₃Si₄O₁₀(OH)₂ or 3MgO.4SiO₂.H₂O) A small level of talc can have a positive effect on the Limiting Oxygen Index (LOI) and UL-94 test results for the coating composition. In an exemplary example, the talc level can be from 1.0-20.0 weight percent of the coating composition, with a preferred level from 3.0-15.0 wt %, and more preferably from 5-10 wt %.

In an exemplary embodiment, the coated fire barrier has a thickness of approximately 21.00 mils (0.50 mm), and a weight of approximately 15.00 oz/yd² (509.00 g/m²). The fabric has a 4 Harness Satin (4 HS) Weave, with 48×32 Ends×Picks, Warp Yarn 37 1/0, and Fill Yarn 37 1/0. The coating can comprise high durability acrylic (HDA). The coated barrier can provide a durable, paintable, substantially flat (board-like) surface. The surface can be written, printed, or drawn upon, and can (permanently) hold a visible graphic display. For example, the fire protection barrier can have a (rigid) structure similar to fiberglass sheets, fiberglass panels, fiberboard, plasterboard, etc. The surface can be smooth, corrugated, or patterned, etc.

The barrier properties include low flame spread and smoke generation. In an exemplary embodiment the coated barrier can resist temperatures to 1000° F. (538° C.). Thus, the coated fire barrier can act as a fire resistant board (structure), which can be manually handled and positioned. The coated barrier also resists moisture and mildew. An example of a fire barrier that is useable in an exemplary laminate is Z-Hull F-407, which is a Z-Shield HB Facing Fabric from Newtex Industries, Inc.

The film material can be of the vinyl type, which has an unprinted film thickness of approximately 2.0 mil (0.05 mm). The vinyl may be transparent or opaque (white or black). An example of a film material that can be used in the exemplary laminate is 3M™ Scotchaff 3650 material (e.g., Graphic Film 3650-10 White). Artwork (e.g., a message, a notice, a warning, a label, an advertisement, etc.) can be affixed to (e.g., ink printed on) the film material.

Another (alternative) graphic film material that can be used in an exemplary laminate is a Hexis vinyl film (such as Hexis V3000WM, Hexis V3000WMB, etc.). For example, Hexis V3000WM can have a PVC film thickness of 100 microns, a total caliper of 270 microns, and a total specific weight of 290 g/m². The graphic PVC film used can be a monomeric calendered cadmium-free vinyl film coated with a thickness of 3.9 mils (100 microns), with a (grey) pressure sensitive acrylic permanent adhesive, and with a matt finish. A usable liner can be siliconed kraft paper (137 g/m² unprinted) with an acrylic adhesive.

An intermediate adhesive is located between the film material and the fire barrier. In an exemplary embodiment, the total thickness (of film plus adhesive) is in the range of approximately 3.15-3.94 mil (0.08-0.10 mm). Thus, the adhesive thickness alone is in the range of approximately 1.15-1.94 mil. The intermediate adhesive can be provided as an integral (already affixed) stock part of the film material. For example, if stock adhesive is provided as part of the Scotchal™ 3650 material, then it can be used as the intermediate adhesive. The intermediate adhesive can include etched aluminum, anodized aluminum, chrome, acrylic enamel, and acrylonitrile-butadiene-styrene copolymer (ABS).

The outermost protective cover can comprise a clear polyvinyl fluoride (PVF) film, with a film thickness of approximately 1.0 mil+/−10%. The protecting cover (overlaminate) can offer excellent anti-graffiti, scratch-resistance, chemical-resistance, smudge-resistance, moisture protection, and dirt protection. The protecting cover can be a flame retardant material that provides excellent flame resistance. An outer (pressure-sensitive, clear, acrylic) adhesive can be used to adhere the PVF film to the printed film material. The outer adhesive can have a thickness of approximately 0.9-1.0 mil+/−0.1. The outer adhesive can be provided as an integral (already affixed) part of the film material.

An example of a protective covering that can be used in the exemplary laminate is FLEXmark® 100 (e.g., FLEXmark® OT 100 clear V-22 42 White PP-8; Tedlar®), which is a product available from FLEXcon. The outer adhesive can be a DuPont adhesive, such as acrylic adhesive 68040, acrylic adhesive 68080, or resin solution 68065 and acrylic adhesive 68070. For example, the acrylic adhesive 68080 can be pre-applied to the Tedlar® PVF film to facilitate lamination of the vinyl film material (which includes the printed message or advertisement thereon).

Other (alternative) protective covering materials that can be used in an exemplary embodiment are FLEXmark® OF 100; Lexan material (e.g., Lexan FR65); and Hexis V700S. For example, V700S can comprise a transparent monomeric vinyl with a thickness of 3 mil (80 microns), with an acrylic solvent-based permanent adhesive, with a paper liner (e.g., 80 g/m²), and with a satin finish.

An exemplary embodiment includes a fire-resisting laminate structure that comprises a fire protection barrier layer having a thickness of approximately 21.00 mils+/−10%, where the fabric has a weight in the range of approximately 13.5-15.0 oz/yd²+/−10%; a vinyl film material (display) layer having a thickness of approximately 2.0 mils+/−10%; and a PVF film (protection) layer having a thickness of approximately 1.0 mil+/−10%.

Thus, an exemplary laminate can have a total thickness that is in the range of approximately 28-29 mils (e.g., 28.5 mils). This total thickness includes the individual thickness of each of the inner adhesive, the coated fire barrier, the intermediate adhesive, the film material with printed artwork, the outer adhesive, and the protective transparent outer cover. The total thickness is when the laminate is affixed to the aircraft component (and all kraft liners were removed). It should be understood that variances may occur during manufacture of the individual layers (e.g., an adhesive layer thickness), during manufacture of the layered laminate, and thereafter during compression (compaction during packing, etc.). These factors may cause additional varying in the total thickness of the laminate. Also, it should be understood that the approximately range of 28-29 mils includes any of the specific individual thicknesses therein (e.g., 28.00, 28.10, 28.20, 28.25 . . . 28.50 . . . 28.75, 28.80 28.90, 28.99, 29.00).

Of course, including a (not yet removed) inner kraft liner (with a thickness in the range of approximately 3.2-6.5 mils) on the inner adhesive would increase the total thickness. Such a removable inner kraft liner may remain with the laminate (such as during its transport) until the laminate is ready to be affixed to the aircraft component. Thus, an exemplary laminate may have a transport thickness that is in the range of approximately 31-36 mils. Again, it should be understood that the approximately range of 31-36 mils includes any particular individual thickness therein.

An exemplary process for manufacturing the laminate includes digitally printing (e.g., via an inkjet printer) the artwork (e.g., an advertisement) on the outer side of the film material (e.g., 3M™ 3650 material). This step creates a printed material. Then the printed side of the film material is laminated with the clear (transparent) protective cover (e.g., FLEXmark® OT 100). The outer adhesive is used to adhere the protective cover to the film material. This step creates a laminated print. Next, the inner side of the laminated print is adhered (via the intermediate adhesive) to the outer side of the fire barrier (e.g., coated fabric Z-Hull F-407). This step creates an artwork fire barrier. Next, one side of adhesive tape (e.g., 3M™ 9372 tape) can be applied to the innermost side of the artwork fire barrier. The other side of the adhesive tape can then be used to connect or attach (adhere, firmly stick, cohere, hold, cling, or bond) the artwork fire barrier to the aircraft component.

Of course other steps (e.g., intermediate steps) can also be employed in the process of creating (assembling) the laminate structure. At least some portions of the laminate assembly (e.g., the printing, the placement of the layers, etc.) can also be automated, with the operation (e.g., operation of one or more assembly machines) being controlled by one or more computers or processors. The processors operate according to computer executable instructions which direct specific assembly functions. In some embodiments the entire assembly process can be fully automated.

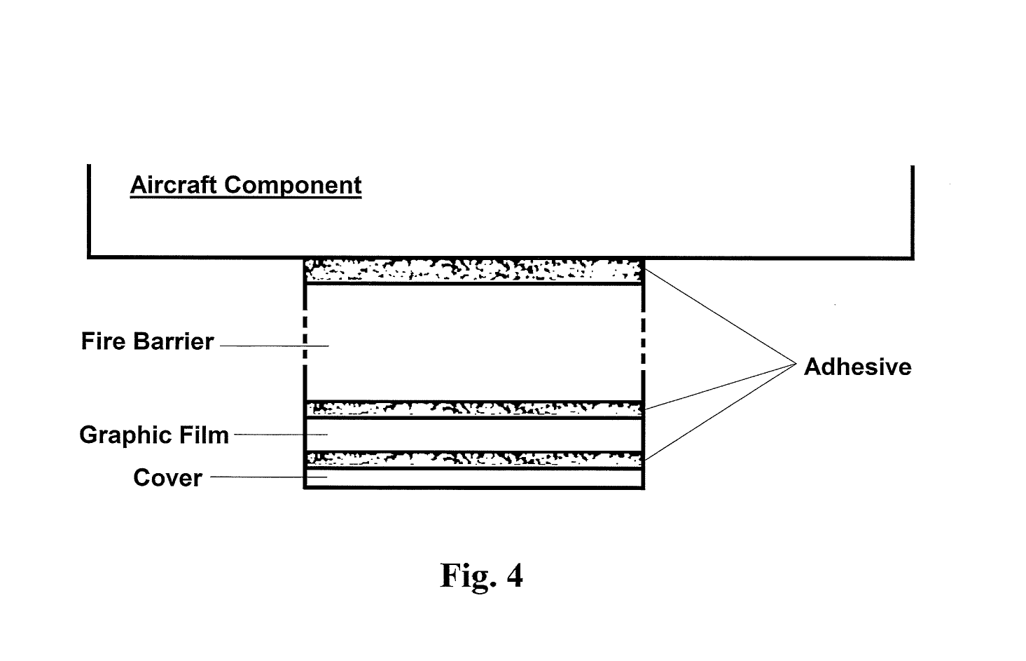

FIG. 4 shows an example of an exemplary laminate where the message is provided on an intermediate layer of graphic film. As can be seen, the laminate includes a (inner) fire barrier layer, a graphic film layer, and a (outer) protective cover layer. Adhesive is shown as being located between the layers. In FIG. 4 the (fire barrier portion of the) laminate is shown affixed (via an adhesive) to a base portion of an aircraft component (at the outer surface thereof).

The laminate can be removably attached (connected) to the component in a manner that allows for later removal of the laminate from the component. For example, the removal process may include heat treating the laminate (or its adhesive attachment area) to allow for its (manual) removal from the aircraft component. That is, heating the adhering adhesive which is located between the fire barrier and the aircraft component enables the remaining laminate to be physically moved away from the component. An alternative removal process can include physically scraping (or peeling, cutting, etc.) the laminate away from the aircraft component. Of course other known methods can be used for separating first and second structures connected by an adhesive.

Also, in other embodiments only certain layers of the laminate structure may need to be replaced in order to change the message (e.g., advertisement). That is, the fire barrier can remain (permanently) affix to the aircraft component. Thus, the removal process may only include removing the display layer (i.e., the graphic film layer) and the protective cover layer attached thereto. A new display layer can be provided which includes a new message (e.g., advertisement). This new display layer (with a new protective cover affixed thereto) can then be attached to the initial fire barrier (which remained affixed to the aircraft component). As a result, the fire-resisting laminate allows for the advertisement presented therein to be easily updated.

It should be understood that more or fewer steps can be applied in an alternative processes of creating and attaching exemplary printed laminate structures. For example, in an alternative manufacturing process the artwork can be printed directly onto the outer surface of the (board-like) coated fire barrier. This eliminates need of a separate film material (for placing the artwork on). Next, the printed side of the fire barrier is layered with (via an adhesive) the protective outer covering. Adhesive tape can then be applied to the unprinted (opposite) side of the fire barrier. The other (opposite) side of the adhesive tape can later be used to attach the printed laminate (with fire barrier) to a designated aircraft component. Thus, a printed laminate is created which is ready to be transported for attachment to an aircraft component.

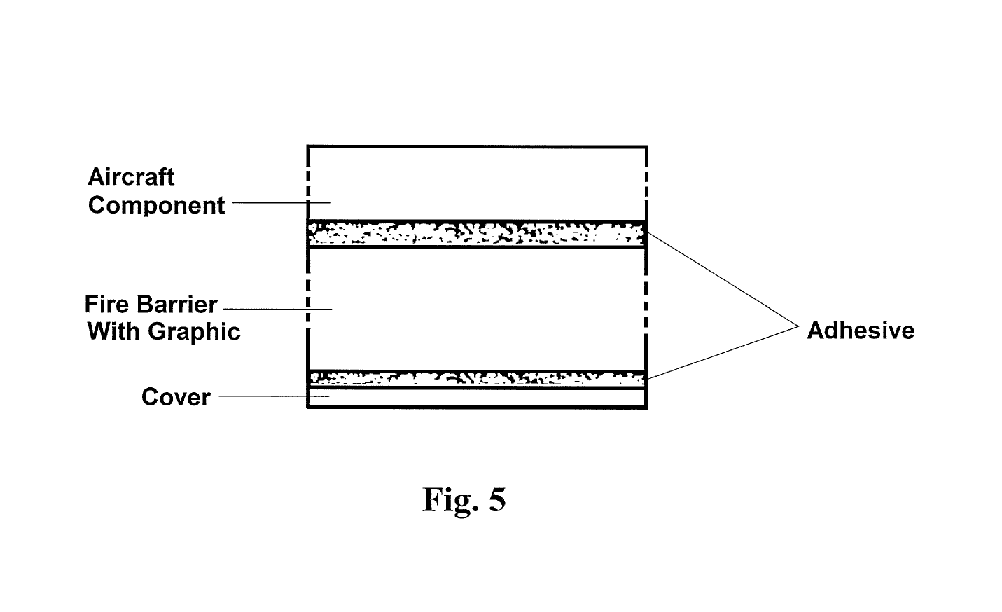

FIG. 5 shows an example of an alternative exemplary laminate where the message is provided on the coated fire barrier. In FIG. 5 the laminate is affixed to an aircraft component.

Thus, an exemplary laminate (in which the artwork is printed directly on the coated fire barrier) can have a total thickness of approximately 25 mils (e.g., 24-26 mils). This total thickness includes the individual thickness of each of the inner adhesive, the coated fire barrier with printed artwork thereon, the outer adhesive, and the protective outer cover. It should be understood that the range of 24-26 mils includes any particular individual thickness (e.g., 25.07 mils) therein.

As is known, adhesive tape can be provided (on both sides) with a coating (e.g., a polycoated kraft liner) that gets removed prior to adhesive usage. Thus, the unused side of the adhesive tape may be covered by a kraft paper, which can later be peeled off to reveal the remaining adhesive material, which is for affixing the printed laminate to the aircraft component.

It should be understood that the step of attaching adhesive tape to the unprinted (inner) side of the fire barrier can be performed at any time in the laminate preparing process. However, one may wait to be sure that both the printing step and the protective cover-applying step were successful before applying the adhesive tape to the fire barrier.

Many variations of the exemplary embodiments will be understood by those skilled in the art. Example variations include placing the barrier in different locations within the sandwich, for example as a middle or outer layer. Other variations call for additional ways in which the product can be applied to the aircraft materials/parts. Even further variations can include multiple combinations of the barriers or ways in which they are applied or included in the exemplary embodiments. Other variations include fire barrier materials and other materials that when placed within the layered formation of exemplary embodiments in a layered sandwich or laminate structure (for example between the graphic materials and the interior aircraft material/parts) provide the protection against fire as well as a reduction in heat release and smoke density that assists the airline/media company when passing the heat release tests. All such variations are within the scope and spirit of the exemplary embodiments.

Other alternative embodiments of exemplary laminates can also be used. Again, the exemplary embodiments allow for a structural form of an advertising message laminate to be applied generally to any area inside the aircraft which must meet FAR 25.853 requirements. The particular (advertising message) laminate structure (or layered arrangement) to be used may depend on the specific material of the particular surface to which it is to be adheredly attached. That is, a partial laminate structure (which comprises only certain layers) may be used in some embodiments instead of a fully layered laminate structure (which comprises all of the layers, including a fire protection barrier layer).

For example, a cabin tray table may be of a material which requires less stringent fire retarding requirements. That is, a fire protection barrier (e.g., Z-Hull F-407) may not be necessary in the (advertising) laminate material that gets attached to a tray table. Thus, the tray table material (with a substantially flat surface) may receive an attached laminate structure that (only) comprises a transparent vinyl protective layer (e.g. Hexis V700S), a graphic film (e.g., Hexis V3000WM, Hexis V3000WMB, or 3M™ 3650), and an appropriate adhesive(s). The laminate structure is adhesively adhered to the (flat, smooth) tray table surface.

Also different surfaces of the cabin tray table may have different messages (advertisements). The back/bottom surface (which is visible when the tray is in an upward position and is not being used) may display a first message, whereas the front/top surface (which is visible when the tray is in a downward position and is being used) may display a second message. The messages may be unrelated. Alternatively, the messages may be (sequentially) related. For example, the first message (which can be first viewed by the passenger during seating) may introduce the passenger to the product/service, whereas the second message (which can be viewed by the passenger during meal time) may reinforce or add to the value of the product/service.

A windscreen window may be of a material which also requires less stringent fire retarding requirements. That is, a fire protection barrier (e.g., Z-Hull F-407) may not be necessary in the (advertising) laminate material that gets attached to the windscreen window. Thus, the windscreen window may receive an attached laminate structure that (only) comprises a protective layer (e.g. Lexan FR65), a 3M™ 9372 adhesive layer, and a graphic film layer (e.g., Scotchal™ 3650). The laminate structure is adhesively adhered to the surface of an area of the windscreen window.

Of course other cabin surfaces can receive a full laminate structure. Again, a fully layered laminate can include each of an outer protective layer (e.g. Flexmark 100), a printed message film layer (e.g., Scotchal™ 3650), a fire protection barrier layer (e.g., Z-Hull F-407), and an affixing adhesive layer (e.g., 3M™ 9372 adhesive) which attaches the entire laminate to the cabin component's surface. As previously discussed, the cabin surface area that receives a fully layered (advertising) laminate structure can be a part of any of an overhead bin/door, a sidewall panel, a bulkhead wall panel, a ceiling structure or panel, a personal service unit, a closet/storage door, a cockpit door, etc.

The exemplary display laminates may also include a printed/stamped code, symbol, or lettering which (visibly) indicates (e.g., such as to the laminate installer or purchaser) the laminate's part number or identifier (ID), and/or an ID of the cabin component which is to receive the display laminate, etc. For example, the printed ID may be set in a corner of the graphic display layer, and have a dimension (with clarity) that is both visible and legible.

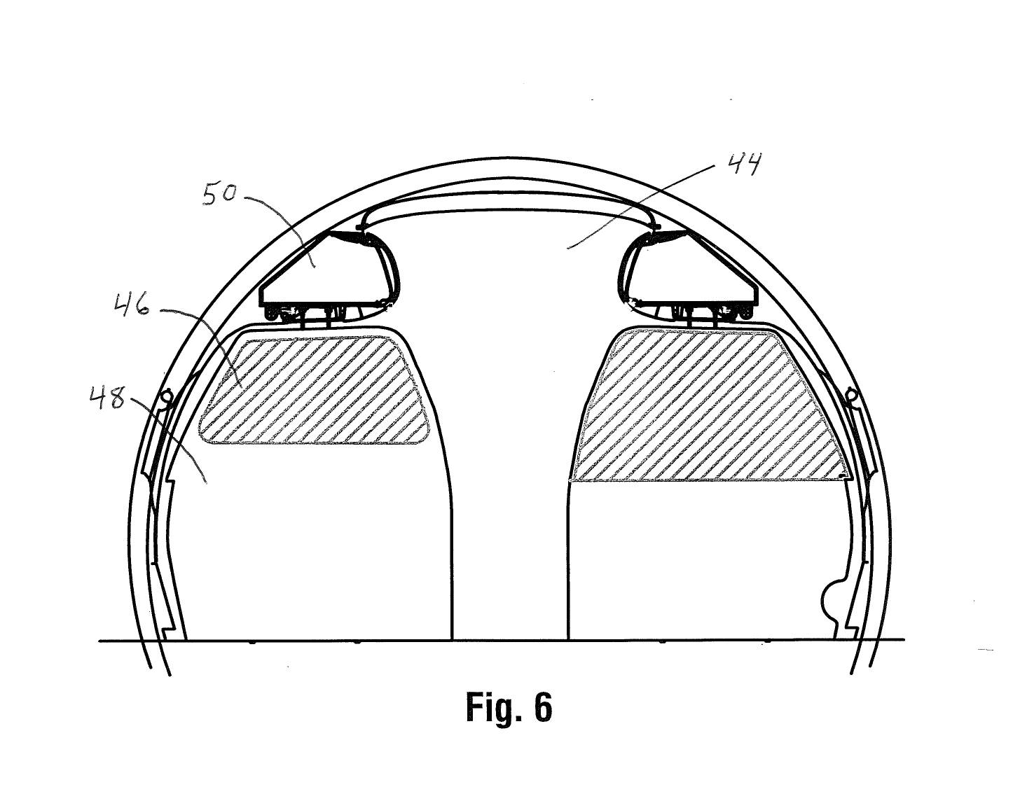

FIGS. 6-9 each show a different exemplary artwork display laminate (e.g., an advertisement message) respectively attached to a respectively different cabin component. FIG. 6 shows a cross section of a cabin area 44. A message placard (e.g., an advertisement display laminate) 46 is shown strategically positioned in attached relation on a bulkhead (wall) portion 48. A portion of an overhead bin 50 is also shown in FIG. 6.

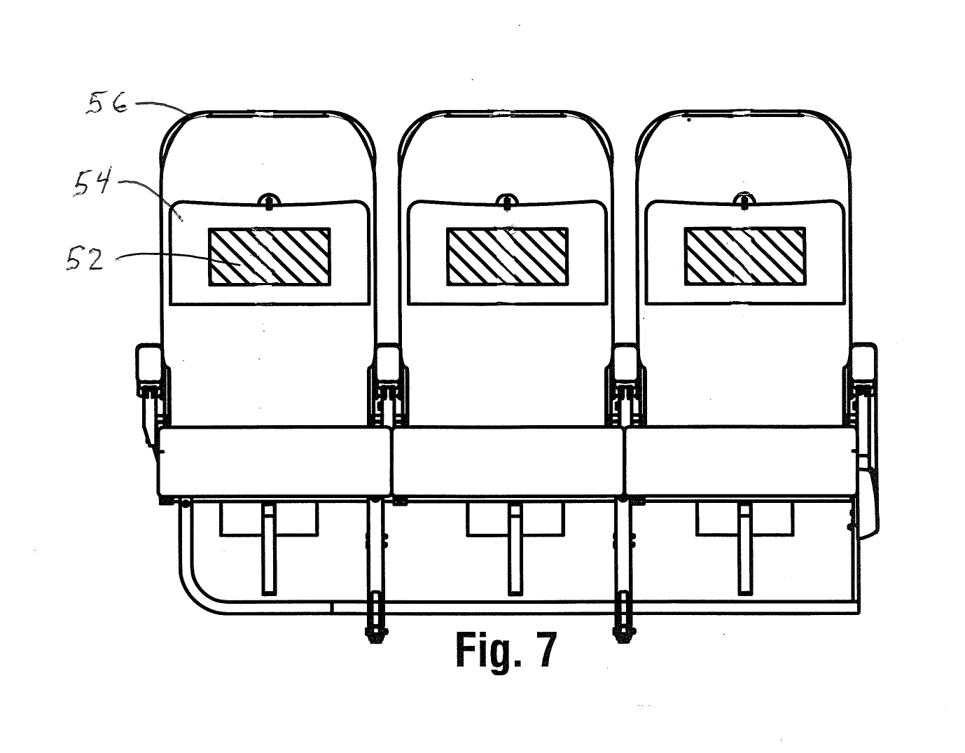

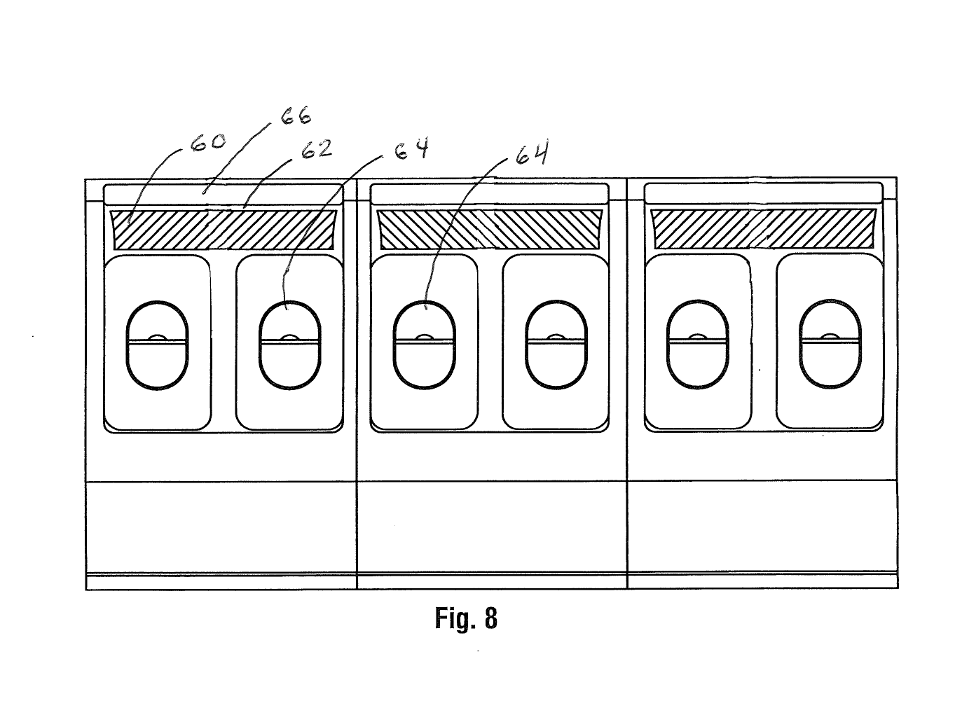

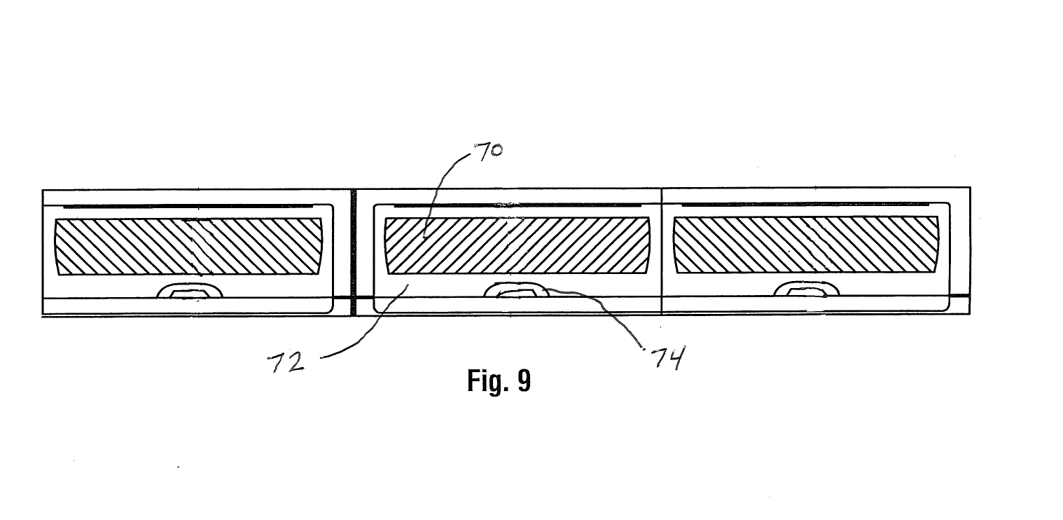

FIG. 7 shows an exemplary artwork display (e.g., advertisement message laminate) 52 attached to a tray table 54, which tray is located on the rear side of a passenger seat 56. FIG. 8 shows an exemplary message laminate 60 attached to a side wall panel 62, which is located above plural passenger windows 64 and below an overhead bin 66. FIG. 9 shows an exemplary message laminate 70 affixed to an overhead bin/door 72 (with grasp or handle 74).

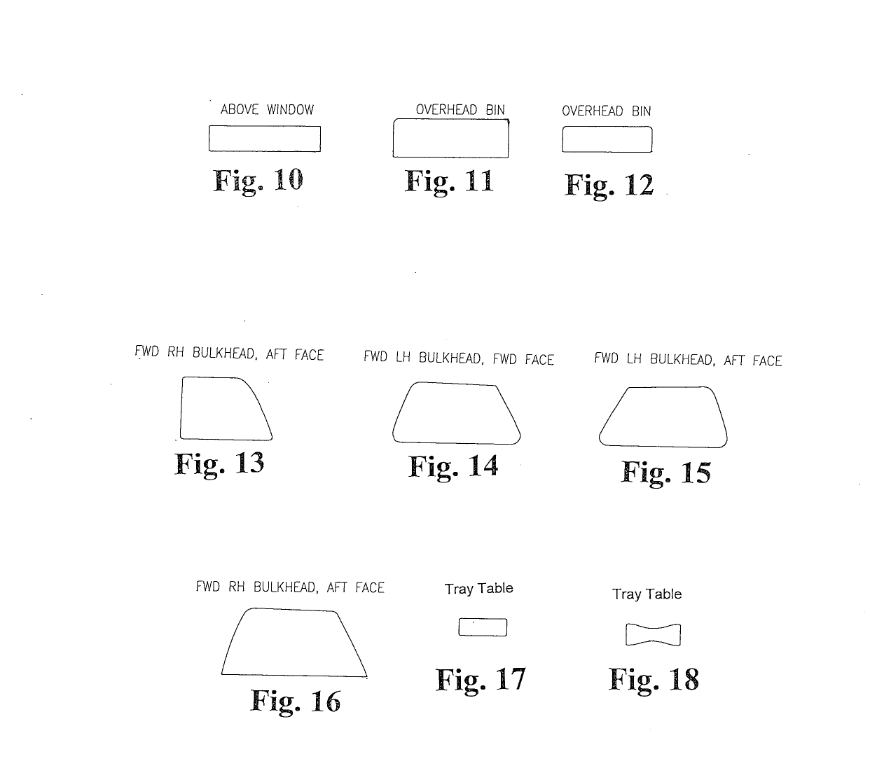

FIGS. 10-18 show exemplary artwork display laminates of different configurations (dimensions/sizes, shapes, contours, etc.). As can be appreciated the ability to provide exemplary display laminates (which meet FAR safety requirements) in different configurations allows for (advertising) messages to placed at numerous locations throughout the interior (cabin or passenger) area of an aircraft. The laminate configuration shown in FIG. 10 may be applied to a panel located above a (passenger) window. The different configurations shown in FIGS. 11 and 12 may be used on an overhead bin. The configuration shown in FIG. 13 may be positioned on a forward right bulkhead, aft face. The configuration shown in FIG. 14 may be used with a forward left bulkhead, forward face. The configuration shown in FIG. 15 may be positioned on a forward left bulkhead, aft face. The laminate configuration shown in FIG. 16 may be positioned on a forward right bulkhead (aft or forward face). The different configurations shown in FIGS. 17 and 18 may be used on a tray table. Because of limited space, only a few laminate configurations and attachment locations have been presented. It should be understood that the exemplary embodiments cover (include, encompass) many additional laminate configurations and interior cabin locations/positions at which the display laminates may be attached/affixed.

Although some embodiments are shown to include certain individual features, it should be understood that any exemplary feature disclosed herein may be used together or in combination with any other feature of the exemplary embodiments. Also, some features may be excluded from certain exemplary embodiments without affecting the intended results.

Further, a person skilled in the art will realize that other embodiments with modifications, additions, and/or deletions thereto, are possible. That is, certain details of embodiments can be modified in a number of respects, all without departing from the novelty set forth in the claims. Thus, the description herein is to be regarded as illustrative in nature and not restrictive.

Thus, the exemplary embodiments achieve improved operation, eliminate difficulties encountered in the use of prior devices and systems, and attain the useful results described herein.

In the foregoing description certain terms have been used for brevity, clarity and understanding. However, no unnecessary limitations are to be implied therefrom because such terms are used for descriptive purposes and are intended to be broadly construed. Moreover, the descriptions and illustrations herein are by way of examples and the claimed invention is not limited to the features shown and described.

Further in the following claims any feature described as a means for performing a function shall be construed as encompassing any means known to those skilled in the art as being capable of carrying out the recited function and shall not be deemed limited to the particular means shown or described for performing the recited function in the foregoing description or mere equivalents thereof.

Use of the term “non-transitory” with regard to the claims is intended to exclude only the subject matter of a transitory signal per se, where the medium itself is transitory. Use of “non-transitory” is not intended to exclude any other form of computer readable media, including media comprising data that is only temporarily stored or stored in a transitory fashion. Should the law change to allow computer readable medium itself to be transitory, then this exclusion is no longer valid or binding upon the claims.

Having described the features, discoveries and principles of the exemplary embodiment, the manner in which it is constructed and operated and the advantages and useful results attained, the new and useful structures, devices, elements, arrangements, parts, combinations, systems, equipment, operations, methods, processes and relationships are set forth in the appended claims.

I claim:

1. A method of manufacturing a fire-resisting laminate structure configured for connection to an interior component of an aircraft, comprising:
(a) providing a first laminate component including a vinyl film layer,
wherein the vinyl film layer has a thickness of approximately 2.0 mils+/−10%,
wherein the vinyl film layer includes at least one graphic marking disposed directly on a side thereof;
(b) providing a second laminate component including a fire-resisting transparent polyvinyl fluoride (PVF) film layer,
wherein the PVF film layer has a thickness of approximately 1.0 mil+/−10%;
(c) using a first adhesive material to directly adhere the second laminate component to the first laminate component,
wherein the first adhesive material comprises a pressure-sensitive clear acrylic adhesive,
wherein the first adhesive material has a thickness in the range of approximately 0.9-1.0 mil+/−0.1,
wherein the at least one graphic marking is visible through the second laminate component;
(d) providing a third laminate component including a fire-resisting coated fire protection layer,
wherein the fire protection layer includes a fabric,
wherein the fabric includes continuous filament fiberglass woven from glass yarn,
wherein the fabric has a weight in the range of approximately 13.5-15.0 oz/yd²+/−10%,
wherein the fire protection layer includes at least one brominated compound,
wherein the fire protection layer has a thickness of approximately 21.00 mils+/−10%;
(e) using a second adhesive material to directly adhere the first laminate component to a first side of the third laminate component,
wherein the second adhesive material comprises a pressure-sensitive adhesive; and
(f) applying a third adhesive material to a second side of the third laminate component,
wherein the second side is opposite the first side,
wherein the third adhesive material comprises a tackified acrylic-based pressure-sensitive adhesive,
wherein the third adhesive material enables at least a portion of the laminate structure to be adheredly connected to the interior component.

2. The method according to claim 1 wherein the steps (a)-(f) are sequentially performed.

3. The method according to claim 1 wherein in (d) the fire protection layer includes at least one antimony oxide compound, and further comprising:
(g) subsequent to (f), die cutting the laminate structure using a shaped template to produce at least one finished laminate product which is adheredly connectable to the interior component.

4. The method according to claim 1 wherein (a) includes printing the at least one graphic marking on the vinyl film layer.

5. The method according to claim 4 wherein the at least one graphic marking includes ink colors.

6. The method according to claim 5 wherein the at least one graphic marking comprises an advertisement.

7. The method according to claim 5 and further comprising:
(g) subsequent to (a) and prior to (c), allowing the ink colors to dry for a predetermined time period.

8. The method according to claim 1
wherein the first laminate component comprises 3M™ Scotchaff 3650 material,
wherein the second laminate component comprises Tedlar® PVF film,
wherein the third laminate component comprises Z-Hull F-407, and
wherein the third adhesive material comprises an adhesive portion of 3M™ 9372 adhesive tape.

9. The method according to claim 1 and further comprising:
(g) subsequent to (f), using the third adhesive material to directly adhere the laminate structure to the interior component.

10. The method according to claim 9 wherein in (g) the interior component comprises one of: an overhead storage bin, an overhead bin door, a sidewall panel, a bulkhead, a window surround, or a lavatory surface.

11. Apparatus comprising a fire-resisting laminate structure sequentially comprising:
(a) a first layer comprising a tackified acrylic-based pressure-sensitive adhesive material;
(b) a second layer comprising a coated fire protection barrier,
wherein the barrier includes a fabric,
wherein the fabric includes continuous filament fiberglass woven from glass yarn,
wherein the fabric has a weight in the range of approximately 13.5-15.0 oz/yd²+/−10%,
wherein the barrier includes at least one brominated compound,
wherein the barrier has a thickness of approximately 21.00 mils+/−10%;
(c) a third layer comprising a pressure-sensitive adhesive material;
(d) a fourth layer comprising an vinyl film material,
wherein the film material has a thickness of approximately 2.0 mils+/−10%,
wherein the film material includes an outer surface,
wherein the outer surface includes at least one graphic marking printed thereon;
(e) a fifth layer comprising a pressure-sensitive clear acrylic adhesive;
wherein the adhesive has a thickness in the range of approximately 0.9-1.0 mil+/−0.1,
wherein the at least one graphic marking is viewable through the fifth layer; and
(f) a sixth layer comprising a transparent cover,
wherein the cover includes polyvinyl fluoride (PVF) film,
wherein the PVF film has a thickness of approximately 1.0 mil+/−10%,
wherein the at least one graphic marking is viewable through the sixth layer.

12. The apparatus according to claim 11 wherein in (d) the at least one graphic marking includes ink colors.

13. The apparatus according to claim 12 wherein the at least one graphic marking comprises an advertisement.

14. The apparatus according to claim 13 wherein the first layer enables at least a portion of the laminate structure to be adheredly connected to an interior component of an aircraft,
wherein the interior component comprises one of: an overhead storage bin, an overhead bin door, a sidewall panel, a bulkhead, a window surround, or a lavatory surface.

15. The apparatus according to claim 14 and further comprising the interior component, wherein the first layer is adheredly connected to the interior component.

16. The apparatus according to claim 11
wherein in (a) the first layer comprises an adhesive portion of 3M™ 9372 adhesive tape,
wherein in (b) the second layer comprises Z-Hull F-407,
wherein in (d) the fourth layer comprises 3M™ Scotchaff 3650 material, and
wherein in (f) the sixth layer comprises Tedlar® PVF film.

17. The apparatus according to claim 16 wherein in (b) the barrier includes at least one antimony oxide compound, and wherein in (e) the adhesive comprises one of acrylic adhesive 68040 or acrylic adhesive 68080.

18. Apparatus comprising an aircraft cabin component:
wherein the aircraft cabin component comprises a base portion and an outer fire-resisting laminate portion,
wherein the base portion comprises a polymer matrix composite material,
wherein the laminate portion comprises a plurality of overlaying layers,
wherein the layers include an inner fire protection barrier layer,
wherein the fire protection barrier layer is adhesively adhered to the base portion,
wherein the fire protection barrier layer comprises a fabric that includes a coating,
wherein the coating includes at least one brominated compound, at least one antimony oxide compound, and high durability acrylic,
wherein the fabric is silica-based,
wherein the fabric is woven from glass yarn,
wherein the fabric includes continuous filament fiberglass,
wherein the fabric comprises properties of:
a 4 harness satin weave,
ends×picks=48×32,
a weight in the range of approximately 13.5-15.0 oz/yd²,
a thickness of approximately 21.00 mils,
warp yarn=37 1/0, and
fill yarn=37 1/0;
wherein the layers include an intermediate display layer,
wherein the display layer comprises a film material,
wherein the film material includes an advertising message printed thereon,
wherein the film material is adhesively adhered to the fire protection barrier layer,
wherein the layers include an outer cover layer,
wherein the cover layer is adhesively adhered to the display layer,
wherein the cover layer includes a polyvinyl fluoride (PVF) film,
wherein the PVF film has a thickness of approximately 1.0 mil+/−10%,
wherein the PVF film includes a transparent portion,
wherein the transparent portion allows the advertising message to be viewed,
wherein the thicknesses and sequential order of the layers of the laminate portion allow the laminate portion, when exposed to an external radiant heat flux of approximately 35 kW/m², not to exceed:
a peak heat release rate of 65 kW/m², and
a total heat release of 65 kW min/m² over an initial two minute period following exposure.

19. The apparatus according to claim 18 wherein the base portion is part of one of: an overhead storage bin, an overhead bin door, a sidewall panel, a bulkhead, a window surround, or a lavatory surface.

20. The apparatus according to claim 18
wherein the fire protection barrier layer is adhesively adhered to the base portion via 3M™ 9372 adhesive tape,
wherein the fire protection barrier layer comprises Z-Hull F-407,
wherein the film material comprises 3M™ Scotchal™ 3650 material, and
wherein the PVF film comprises Tedlar®.
